(19) United States
(12) Patent Application Publication
(10) Pub. No.: US 2024/0022139 A1
(43) Pub. Date: Jan. 18, 2024

(54) GAS DRYING SYSTEM AND GAS DRIER

(71) Applicant: Mitsubishi Electric Corporation, Chiyoda-ku, (JP)

(72) Inventors: Katsuya JINNO, Tokyo (JP); Masahiro MIYASHITA, Tokyo (JP); Aritoshi NISHIKAWA, Tokyo (JP); Tsunemi OSADA, Tokyo (JP); Ryoichi NASADA, Tokyo (JP); Hideaki IKEJIMA, Tokyo (JP)

(73) Assignee: Mitsubishi Electric Corporation, Tokyo (JP)

(21) Appl. No.: 18/036,660

(22) PCT Filed: Dec. 24, 2020
(86) PCT No.: PCT/JP2020/048521

§ 371 Date: May 12, 2023

(51) Int. Cl. H02K 9/26

(52) U.S. Cl. CPC H02K 9/26

(57) ABSTRACT

A gas drying system (100) includes an inflow pipe (111), a drying tower (120), and an outflow pipe (112). In the inflow pipe, gas that contains moisture and is mixed with oil flows. The drying tower is packed with desiccant. The drying tower dries gas entering from the inflow pipe with the desiccant. In the outflow pipe, gas after being dried in the drying tower flows. The desiccant has a plurality of pores into which the oil penetrates, the plurality of pores having a pore size greater than or equal to a size of molecules of the oil.

### DESCRIPTION

### Technical Field

The present disclosure relates to a gas drying system for drying gas that contains moisture.

### Background Art

A high-capacity device like a rotating electric machine cools its interior with hydrogen gas, from the viewpoint of cooling effect and power loss. In order to prevent degradation of insulation and condensation in the interior, it is necessary to keep the hydrogen gas in a dried state. Thus, for removal of moisture in the hydrogen gas, a hydrogen gas drier using a desiccant is installed.

In general, activated alumina is used as desiccant. The activated alumina is compounded with cobalt chloride used as a drying indicating agent whose color phase changes. Thus, when no moisture is present, the activated alumina compounded with cobalt chloride is blue. When moisture is present, the activated alumina absorbs moisture and the cobalt chloride turns red. From this, one can visually ascertain the life of the activated alumina and moisture in the hydrogen gas.

When the desiccant has reached the end of its life due to absorption of moisture, an operation of removing the moisture in the desiccant such as by heating and reusing the desiccant is performed.

Patent Literature 1 describes a technique that uses silica gel as desiccant together with cobalt chloride as a drying indicating agent in a hydrogen gas drier.

### CITATION LIST

### Patent Literature

Patent Literature 1: JP S61-156461 U

### SUMMARY OF INVENTION

### Technical Problem

In the arrangement of Patent Literature 1, oil mist originating from lubricating oil in the hydrogen gas drier adheres to the surface of the desiccant. The adhering oil mist degrades and its color turns brown, due to which the desiccant also turns brown. This makes it impossible to observe the change in the color of the drying indicating agent.

In fields that handle high humidity, the method of controlling humidity using a desiccant is a well-known technique. As such, desiccant is also used in hydrogen gas driers. In general, however, humidity and oil mist do not coexist in those fields that handle high humidity. Accordingly, a phenomenon of oil mist adhering to the surface of the desiccant and changing in color is not known. This phenomenon is a phenomenon specific to gas driers. And this phenomenon has not been remedied in the technique of controlling humidity using a desiccant.

An object of the present disclosure is to enable observation of change in the color of a drying indicating agent compounded with a desiccant even in a case where oil mixes with gas.

### Solution to Problem

A gas drying system according to the present disclosure includes:
an inflow pipe in which gas that contains moisture and is mixed with oil flows;
a drying tower which is packed with desiccant and which dries gas entering from the inflow pipe with the desiccant; and
an outflow pipe in which gas after being dried in the drying tower flows, wherein
the desiccant has a plurality of pores into which the oil penetrates, the plurality of pores having a pore size greater than or equal to a size of molecules of the oil.

### Advantageous Effects of Invention

According to the present disclosure, it is possible to observe change in the color of a drying indicating agent compounded with a desiccant even in a case where oil mixes with gas.

### BRIEF DESCRIPTION OF DRAWINGS

FIG. 1 is a structural diagram of a gas drying system 100 in Embodiment 1.

FIG. 2 is a structural diagram of a drying tower 120 in Embodiment 1.

FIG. 3 is a structural diagram of a desiccant 130 in Embodiment 1.

FIG. 4 shows the gas drying system 100 (during reactivation) in Embodiment 1.

FIG. 5 shows lubricating oil 132 that has adhered to the desiccant 130 in Embodiment 1.

FIG. 6 shows lubricating oil 132 that has penetrated into the desiccant 130 in Embodiment 1.

FIG. 7 shows lubricating oil 132 staying on a surface of desiccant 139 in a comparative example.

FIG. 8 shows a molecular structure of the lubricating oil 132 in Embodiment 1.

FIG. 9 shows a graph of relationship between pore size and color change in Embodiment 1.

FIG. 10 is a structural diagram of a drying tower 120A in Example 1.

FIG. 11 is a structural diagram of a drying tower 120B in Example 2.

FIG. 12 is a structural diagram of a gas drying system 100 in Example 3.

FIG. 13 is a structural diagram of the gas drying system 100 in Embodiment 2.

FIG. 14 is a structural diagram of an oil removing device 140 in Embodiment 2.

FIG. 15 shows tests results for color change level in embodiments.

FIG. 16 shows tests results for color change level in embodiments.

FIG. 17 shows tests results for color change level in comparative examples.

### DESCRIPTION OF EMBODIMENTS

In the embodiments and drawings, the same or corresponding elements are denoted with the same reference characters. Description of an element with the same reference character as an already described element will be omitted or simplified as appropriate.

### Embodiment 1

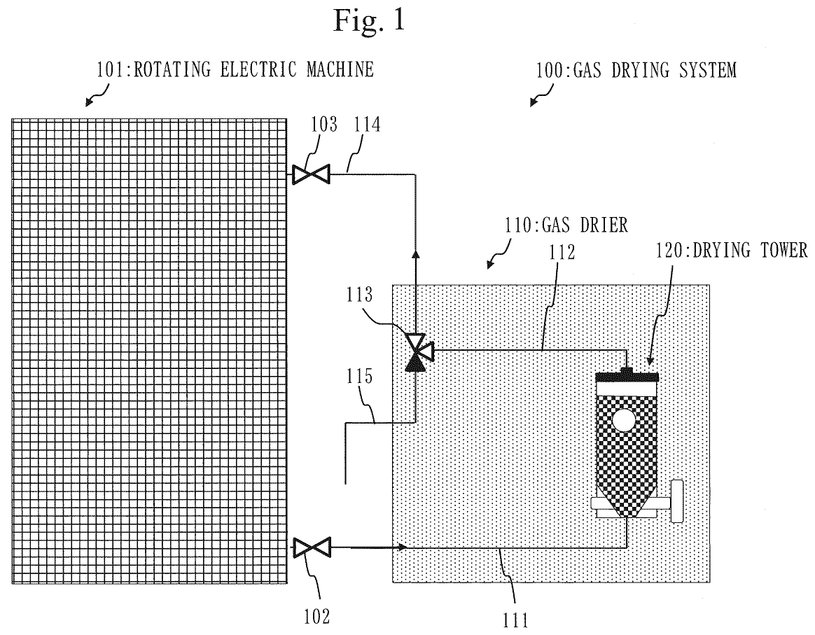

A gas drying system 100 will be described based on FIGS. 1 to 12.

***Description of Configuration***

Based on FIG. 1, configuration of the gas drying system 100 will be described.

The gas drying system 100 includes a rotating electric machine 101 and a gas drier 110.

The rotating electric machine 101 includes a pipe valve 102 and a pipe valve 103.

The gas drier 110 includes a drying tower 120. The gas drier 110 also includes an inflow pipe 111, an outflow pipe 112, a piping switch 113, a return pipe 114, and a drain pipe 115.

On the pipe valve 102, the pipe valve 103, and the piping switch 113, white triangles represent open valves and black triangles represent closed valves.

In the rotating electric machine 101, hydrogen gas is used as a cooling medium for cooling its interior.

The inflow pipe 111 is a pipe connecting the rotating electric machine 101 and the drying tower 120. When the pipe valve 102 is open, hydrogen gas flows down the inflow pipe 111 and enters the drying tower 120.

The outflow pipe 112 is a pipe connecting the drying tower 120 and the piping switch 113. Hydrogen gas exits the drying tower 120 and flows down the outflow pipe 112.

The piping switch 113 is a device for switching a flow channel and includes a valve to which the outflow pipe 112 is coupled, a valve to which the return pipe 114 is coupled, and a valve to which the drain pipe 115 is coupled.

The return pipe 114 is a pipe connecting the rotating electric machine 101 and the piping switch 113. When the pipe valve 103 and the valves of the piping switch 113 except the valve for the drain pipe 115 are open, hydrogen gas flows down the return pipe 114 and returns to the rotating electric machine 101.

The drain pipe 115 is a pipe for discharging drain water.

The drying tower 120 is a device for drying hydrogen gas entering from the inflow pipe 111.

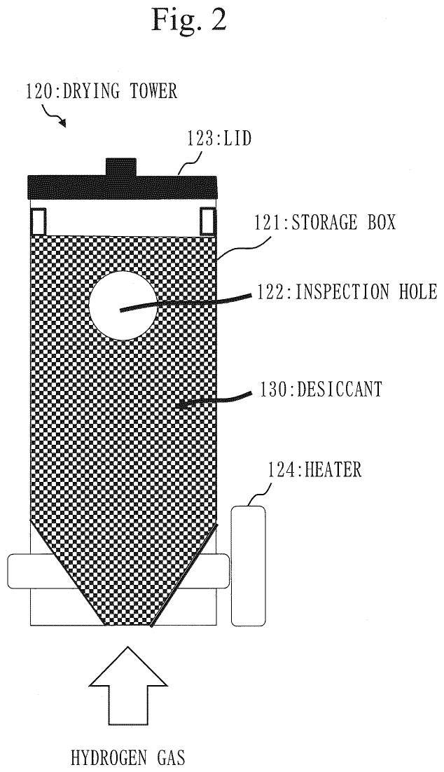

Based on FIG. 2, configuration of the drying tower 120 is described.

The drying tower 120 includes a storage box 121, a lid 123, and a heater 124.

The storage box 121 is packed with a desiccant 130 for drying hydrogen gas. By taking out the storage box 121 from the drying tower 120, one can easily change the desiccant 130.

The desiccant 130 is porous ceramic. For example, the desiccant 130 is activated alumina, silica gel, zeolite, micro-porous silica, or the like. In terms of availability, preferably the desiccant 130 is activated alumina or silica gel.

The storage box 121 has an inspection hole 122 for checking the color of the desiccant 130 from outside. The locations where the inspection hole 122 is provided may be moved or increased/decreased in accordance with application.

From below the storage box 121, hydrogen gas flows into the storage box 121.

An upper portion of the storage box 121 forms a cylindrical shape. A lower portion of the storage box 121 forms a conical shape, a funnel shape, or a tapered shape which is thinner on the lower side. That is to say, a diameter of the storage box 121 near its inlet is small and increases as it goes upward. This can facilitate contact of hydrogen gas with the desiccant 130 to enhance the drying effect.

The lid 123 is attachable to and detachable from the drying tower 120.

The heater 124 heats the desiccant 130. This causes moisture adsorbed in the desiccant 130 to be removed.

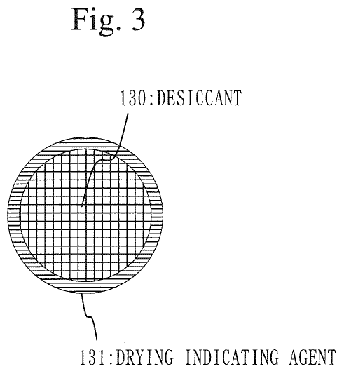

Based on FIG. 3, the structure of the desiccant 130 is described. FIG. 3 shows a cross section of a grain of the desiccant 130.

On the surface of the desiccant 130, a drying indicating agent 131 whose color phase changes is attached.

The drying indicating agent 131 reversibly changes its color in response to moisture. Specifically, the drying indicating agent 131 is cobalt chloride. However, cobalt chloride-free material, such as tetraphenylporphyrin chloride and iron alum, may also be used for the drying indicating agent 131. The drying indicating agent 131 may be determined in accordance with specifications of the gas drying system 100 regarding the thermal resistance of materials, reversibility of color change, discernibility of color change, and so on. For a cobalt chloride-free material, tetraphenylporphyrin chloride is desirable in terms of controlled substance.

The drying indicating agent 131 is compounded with the desiccant 130 such that the color of the drying indicating agent 131 changes when the desiccant 130 absorbs moisture. By visually checking the color of the drying indicating agent 131, one can check the life of the desiccant 130. A visual check can be made through the inspection hole 122 provided in the storage box 121.

The desiccant 130 may be either spherical or non-spherical. The desiccant 130 may also be in crushed form.

However, desiccant 130 of a spherical shape allows for a higher packing rate of the desiccant 130 in the storage box 121 to increase the drying efficiency.

***Descriptions of Functions***

Based on FIG. 1, the gas drying system 100 during operation of the rotating electric machine 101 will be described.

In the rotating electric machine 101, hydrogen gas is used for a cooling medium for cooling the interior.

The hydrogen gas flows from the rotating electric machine 101 through the inflow pipe 111 to enter the drying tower 120.

This hydrogen gas contains moisture after absorbing moisture in the rotating electric machine 101.

The drying tower 120 dries the hydrogen gas having entered it with the desiccant 130.

The dried hydrogen gas flows from the drying tower 120 down the outflow pipe 112, passes through the piping switch 113, flows down the return pipe 114, and returns to the rotating electric machine 101.

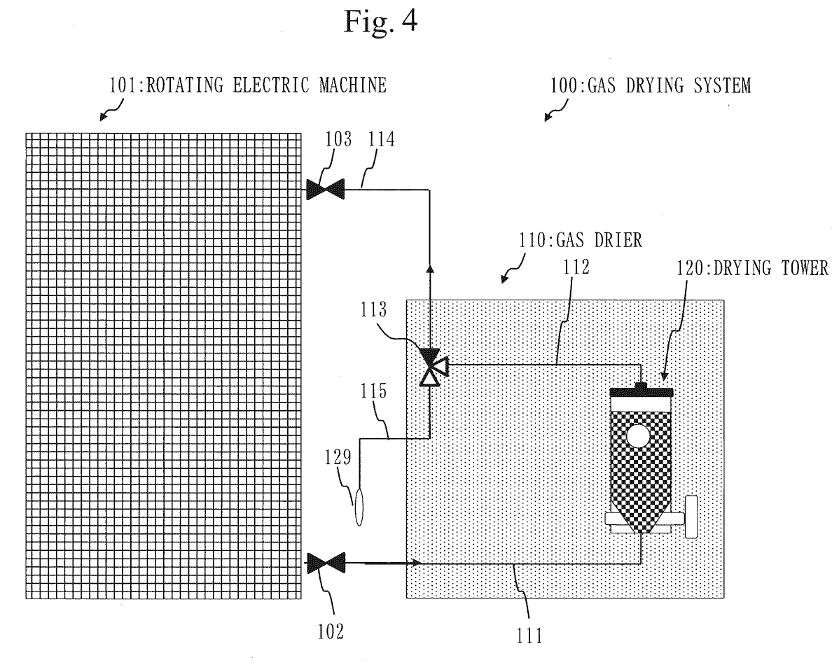

Based on FIG. 4, the gas drying system 100 at the time of reactivation of the desiccant 130 will be described.

The operation of the rotating electric machine 101 is stopped.

The pipe valve 102 and the pipe valve 103 are closed.

At the piping switch 113, the valve to which the return pipe 114 is coupled is closed. The valve to which the outflow pipe 112 is coupled and the valve to which drain pipe 115 is coupled are opened.

The heater 124 of the drying tower 120 generates heat to heat the desiccant 130. This causes moisture adsorbed in the desiccant 130 to be removed. A temperature to which the desiccant 130 is heated is equal to or higher than the boiling point of moisture. It is, however, necessary to consider the heat resisting temperatures of components of the gas drier 110. For example, the desiccant 130 may be heated at around 120 degrees.

After a certain amount of time has passed in this condition, water vapor arising from the moisture adsorbed in the desiccant 130 flows down the outflow pipe 112, passes through the piping switch 113, and flows down the drain pipe 115. Then, the water vapor is discharged from the drain pipe 115 to the outside as drain water 129.

***Descriptions of Features***

In addition to the configurations and functions above, the gas drying system 100 has the following features.

In the rotating electric machine 101, lubricating oil 132 is used at different locations. Consequently, the lubricating oil 132 can mix with hydrogen gas during operation and flow in mist state. Then, when the hydrogen gas is being dried in the drying tower 120, the lubricating oil 132 mixed with the hydrogen gas adheres to the desiccant 130.

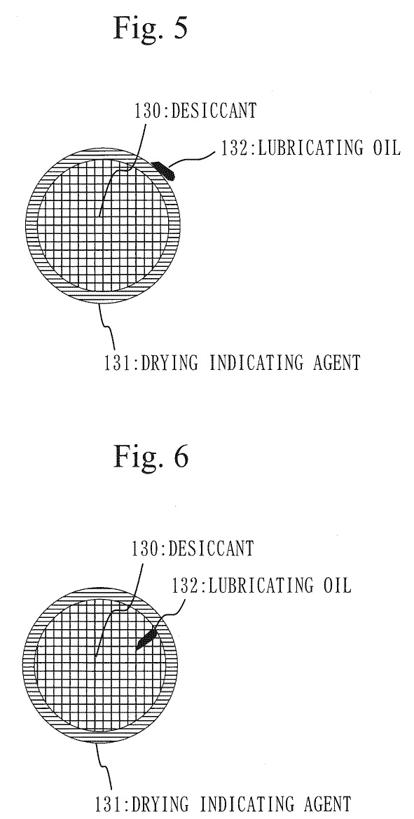

FIG. 5 shows the desiccant 130 immediately after adhesion of the lubricating oil 132 thereto.

The desiccant 130 has multiple pores. Each pore in the desiccant 130 has a pore size equal to or greater than the size of the molecules of the lubricating oil 132. Thus, lubricating oil 132 adhering to the desiccant 130 penetrates inside of the individual pores in the desiccant 130 due to capillarity.

FIG. 6 shows a desiccant 130 into which lubricating oil 132 has penetrated. Since the lubricating oil 132 penetrates inside of the desiccant 130, the lubricating oil 132 is not exposed to air. That is, the lubricating oil 132 is resistant to degradation and less likely to change in color. This allows observation of color change of the drying indicating agent 131.

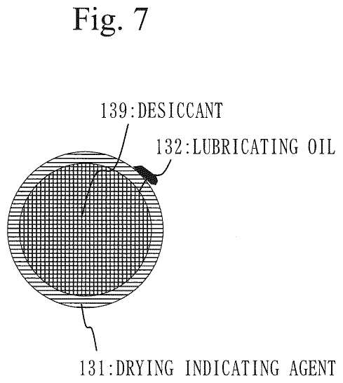

FIG. 7 shows a desiccant 139 as a comparative example with respect to the desiccant 130.

The desiccant 139 has multiple pores. However, each pore in the desiccant 139 has a pore size less than the size of the molecules of the lubricating oil 132.

The lubricating oil 132 cannot penetrate into the pores of the desiccant 139, so it stays on the surface of the desiccant 139. Then, the lubricating oil 132 degrades and turns brown.

In this case, color change of the drying indicating agent 131 is difficult to observe. For example, if the lubricating oil 132 has adhered to the entire surface of the desiccant 139 and the lubricating oil 132 has turned brown, the entire surface of the desiccant 139 appears brown, so that the color change of the drying indicating agent 131 cannot be observed.

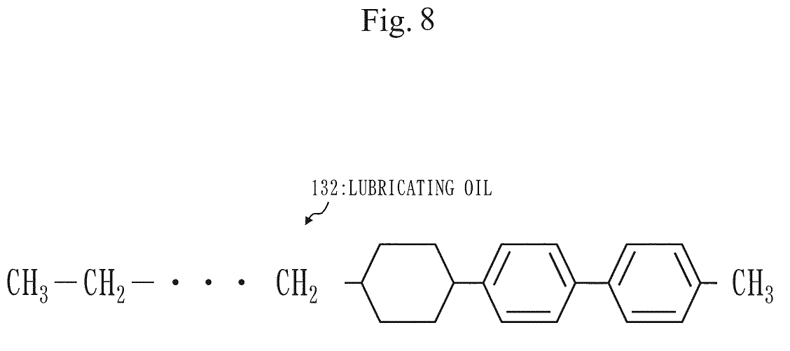

FIG. 8 shows a specific example of a molecular structure of the lubricating oil 132.

The molecular length of the lubricating oil 132 is 5.1 nanometers. This length is determined by molecular weight and interatomic distance.

When the pore size of the desiccant 130 is less than 5.1 nanometers, capillarity does not occur because the lubricating oil 132 cannot enter the pores.

The pore size of the desiccant 130 is equal to or greater than 5.1 nanometers. Thus, the lubricating oil 132 can enter the pores and capillarity occurs. As a result, no color change of the lubricating oil 132 will occur.

Each pore in the desiccant 139 has a pore size equal to or smaller than the wavelengths of visible light.

The lower limit of the wavelengths of visible light is 360 nanometers.

If the pore size of the desiccant 130 exceeds 360 nanometers, the color of the desiccant 130 could appear differently due to the influence of lubricating oil 132 that has penetrated inside of the individual pores. In such a case, the color of the drying indicating agent 131 is difficult to identify even if the lubricating oil 132 does not change in color due to degradation. Thus, the pore size of the desiccant 130 is preferably equal to or less than 360 nanometers.

A pore volume of the desiccant 139 per cubic centimeter is from 0.2 cubic centimeters to 0.7 cubic centimeters inclusive.

The desiccant 139 draws the lubricating oil 132 into its pores. So, if a spatial volume of the pores is small, the lubricating oil 132 can overflow onto the surface of the desiccant 130 and change in color. On the other hand, if the spatial volume of the pores is too large, an insufficient strength of the desiccant 130 will occur.

Accordingly, in a packed state of the desiccant 139, the pore volume per cubic centimeter is preferably from 0.2 cubic centimeters to 0.7 cubic centimeters inclusive. These values are determined based on bulk density [g/cm³] and pore volume [cm³/g]. The pore volume is measured by total pore volume measurement by one point method which is based on the gas adsorption method using nitrogen.

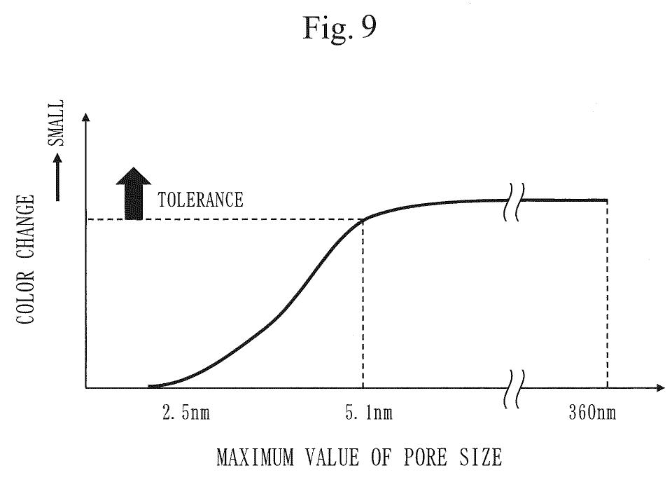

FIG. 9 shows a relationship between the pore size and color change in a case where the lubricating oil 132 of FIG. 8 is used.

From FIG. 9, it can be seen that color change is suppressed when the pore size is equal to or greater than the molecular size of the lubricating oil 132.

A phenomenon of color change is governed by capillarity with parameters being the pore size of the desiccant 130 and the molecular size of the lubricating oil 132. Thus, a maximum value of the pore size of the desiccant 130 should be equal to or greater than the molecular size of the lubricating oil 132.

The maximum value of the pore size is determined by measuring a pore distribution by the gas adsorption method and identifying the maximum pore size in the pore distribution.

### DESCRIPTION OF EXAMPLE 1

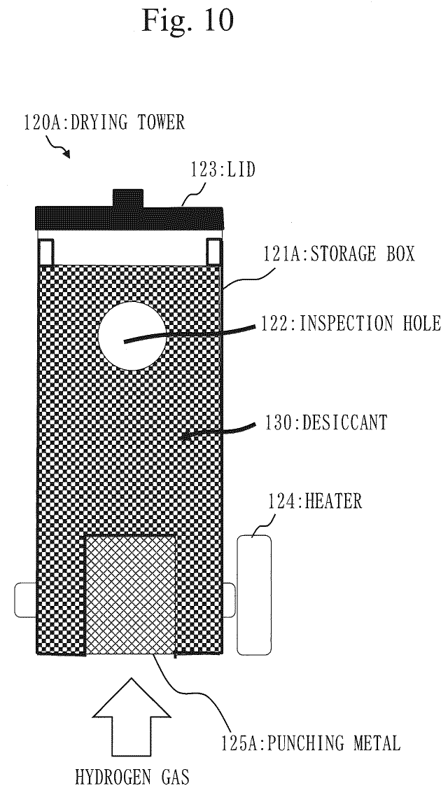

Based on FIG. 10, a drying tower 120A will be described mainly for differences from the drying tower 120. The drying tower 120A is an example of the drying tower 120.

The drying tower 120A includes a storage box 121A.

The storage box 121A includes a cylindrical punching metal 125A in a lower portion thereof. Hydrogen gas flows into the storage box 121A through holes in the punching metal 125A.

As the hydrogen gas flows in every direction over 360 degrees from a side surface of the punching metal 125A, the drying effect is enhanced.

### 2DESCRIPTION OF EXAMPLE 2

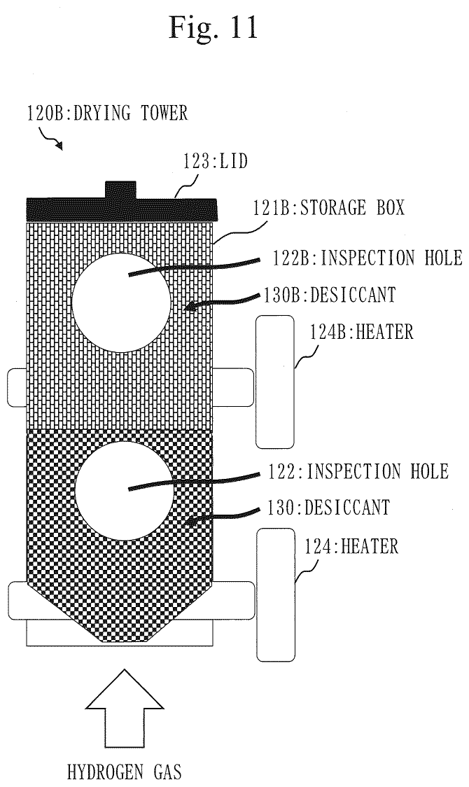

Based on FIG. 11, a drying tower 120B will be described mainly for differences from the drying tower 120. The drying tower 120B is an example of the drying tower 120.

The drying tower 120B includes a storage box 121B.

The storage box 121B is packed with a desiccant 130 and a desiccant 130B in two, upper and lower, tiers. That is, the desiccant 130 and the desiccant 130B are packed in layers on top of each other.

The desiccant 130 and the desiccant 130B are different in at least either of pore size and material. This provides two kinds of drying characteristics.

However, the storage box 121B may be packed with three or more kinds of desiccant. The three or more kinds of desiccant are packed in the drying tower in separate layers for the respective kinds. The storage box 121B may also be provided separately for each layer.

The storage box 121B has an inspection hole 122 for checking the desiccant 130 and an inspection hole 122B for checking the desiccant 130B. That is, the storage box 121B has inspection holes separately for the respective desiccants.

However, the storage box 121B may also have a single inspection hole.

The storage box 121B includes a heater 124 for heating the desiccant 130 and a heater 124B for heating the desiccant 130B.

However, the storage box 121B may include the heater 124 alone. In this case, heat from the heater 124 reactivates the desiccant 130. Heat from the heater 124 also dries hydrogen gas. Then, a flow of the dried hydrogen gas can reactivate the desiccant 130B.

### DESCRIPTION OF EXAMPLE 3

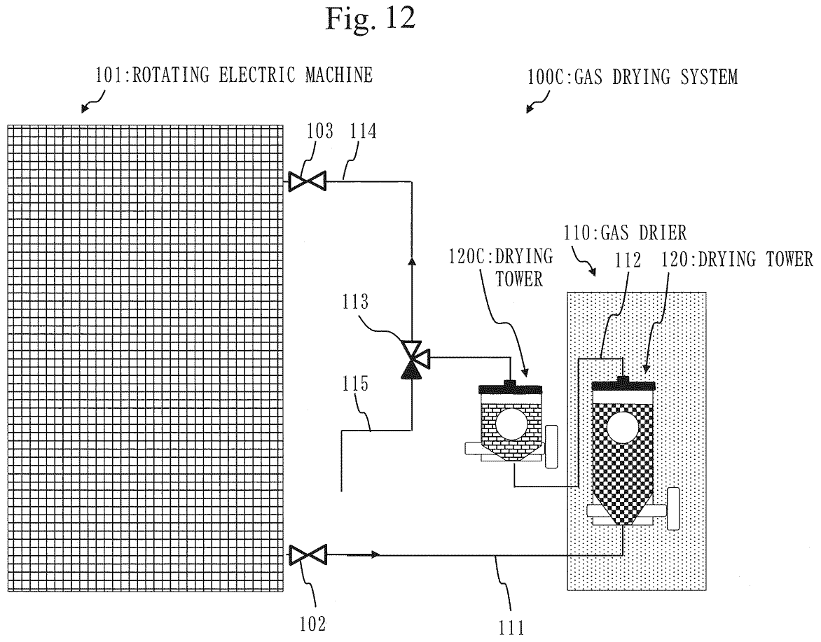

Based on FIG. 12, a gas drying system 100C will be described mainly for differences from the gas drying system 100. The gas drying system 100C is an example of the gas drying system 100.

The gas drying system 100C includes a drying tower 120C outside of the gas drier 110.

The drying tower 120C is connected to an outlet side of the outflow pipe 112.

The drying tower 120C is packed with a desiccant which is different from the desiccant 130 of the drying tower 120 in at least either of pore size and material. This provides two kinds of drying characteristics.

The drying tower 120C dries hydrogen gas entering from the outflow pipe 112 with the desiccant.

The drying tower 120 and the drying tower 120C may respectively include heaters or only the drying tower 120 may include the heater 124. Heat from the heater 124 can reactivate the desiccant 130 in the drying tower 120. Heat from the heater 124 also dries hydrogen gas. Then, a flow of the dried hydrogen gas can reactivate the desiccant in the drying tower 120C.

The gas drying system 100C may also include a further drying tower. EFFECTS OF EMBODIMENT1

The gas drying system 100 dries hydrogen gas with the desiccant 130 which uses the drying indicating agent 131. The maximum pore size obtained in measurement of the pore distribution of the desiccant 130 is the size that allows the lubricating oil 132 to penetrate into the pores by capillarity.

Since the lubricating oil 132 as a cause of color change does not stay on the surface of the desiccant 130, color change of the lubricating oil 132 is prevented and determination of color change of the desiccant 130 becomes possible. This contributes to retention of purity of hydrogen gas and provides the effect of stable performance of a product.

### EMBODIMENT 2

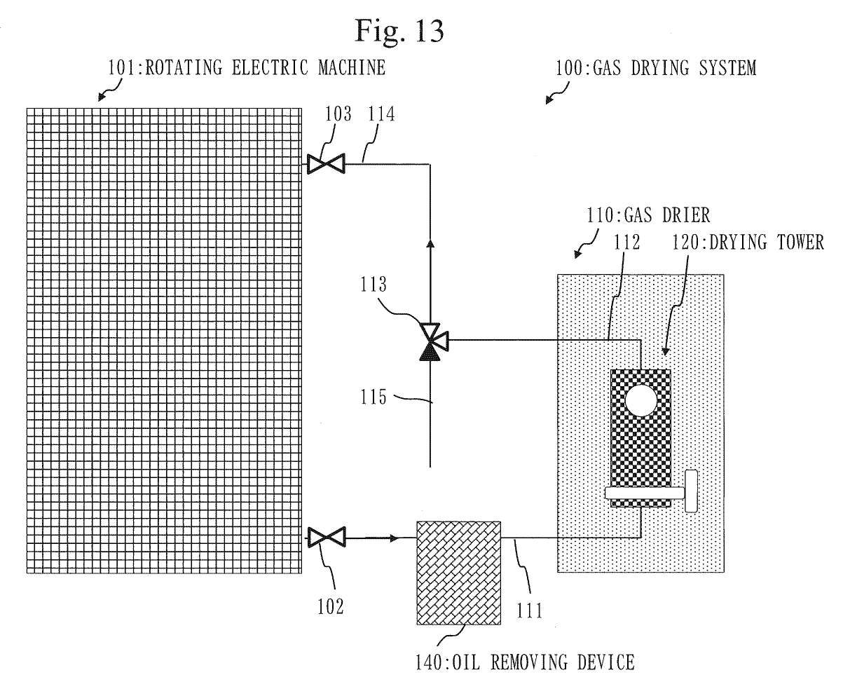

A way of recovering lubricating oil 132 mixed in hydrogen gas will be described based on FIGS. 13 to 17 mainly for differences from Embodiment 1.

***Description of Configuration***

Based on FIG. 13, the configuration of the gas drying system 100 will be described.

The gas drying system 100 further includes an oil removing device 140.

The oil removing device 140 is connected in a middle of the inflow pipe 111 and removes the lubricating oil 132 from the hydrogen gas flowing in the inflow pipe 111 in a cyclone manner.

A cyclone system is advantageous in that it does not cause pressure loss. For example, in an approach where an oil removing filter is used, pressure loss occurs from clogging of the filter and lowers the functionality of the oil removing device.

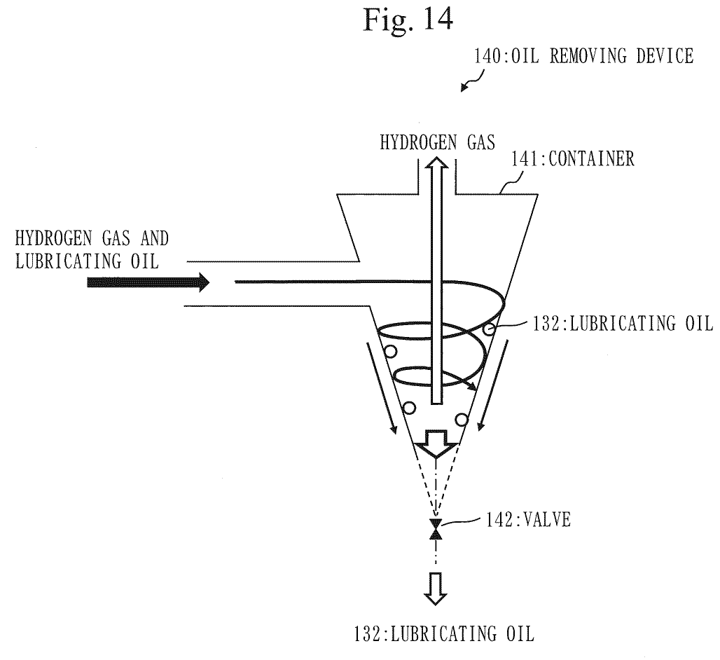

Based on FIG. 14, the configuration of the oil removing device 140 will be described.

The oil removing device 140 includes a container 141.

The container 141 has a conical inner surface. Hydrogen gas flows spirally along the inner surface of the container 141.

For the container 141, an inclination angle θ of the inner surface and a coefficient of static friction μ of the inner surface satisfy tanθ<1/μ.

The inner surface of the container 141 has a coating applied thereon. For example, any of fluorocarbon polymer coating, ceramic coating, and glass coating is used.

***Description of Function***

Based on FIG. 14, the function of the oil removing device 140 will be described.

Hydrogen gas containing a trace amount of lubricating oil 132 flows into the oil removing device 140.

After entering the oil removing device 140, the hydrogen gas falls downward while flowing spirally along the inner surface of the container 141. While doing so, liquid lubricating oil 132 remains on the inner surface of the container 141. The lubricating oil 132 is thereby removed from the hydrogen gas.

Then, when the hydrogen gas has reached a bottom of the container 141, it is discharged to the outside from a top of the container 141 by an ascending air current.

Meanwhile, the lubricating oil 132 flows downward on the inner surface of the container 141. The lubricating oil 132 is then recovered from a drain provided in the bottom of the container 141. A valve 142 to which the drain is connected is closed when the rotating electric machine 101 is in operation and opened when the lubricating oil 132 is being recovered.

***Description of Features***

In addition to the configurations and functions above, the oil removing device 140 has the following features.

If the lubricating oil 132 starts falling by running on the inner surface of the container 141, expressions (1) and (2) hold because the maximum static frictional force is small compared to the force of fall of the lubricating oil 132.
“m” indicates the weight [kg] of a grain of lubricating oil 132;
“g” indicates gravitational acceleration [m/s²];
“θ” indicates the inclination angle of the inner surface of the container 141;
“μ” indicates the coefficient of static friction of the inner surface of the container 141; and
“N” indicates a normal reaction [N] of the inner surface of the container 141.

mg cos θ>μN (1)

N=mg sin θ (2)

On the basis of expressions (1) and (2), expression (3) holds:

tan θ<1/μ (3)

When the inner surface of the container 141 satisfies the expression (3), the lubricating oil 132 will flow downward on the inner surface of the container 141. And it is possible to recover the lubricating oil 132.

For a cyclone-type structure, metal such as iron and aluminum is commonly used. When the inner surface of the container 141 is metal, however, the range of tanθ becomes narrow due to a high coefficient of static friction, lowering the degree of freedom in design of the container 141. Accordingly, coating is applied to the inner surface of the container 141.

For the coating material, fluorocarbon polymer coating, ceramic coating, or glass coating can be used, for example.

This decreases the coefficient of static friction and increases the degree of freedom in the design of the container 141.

Since the oil removing device 140 removes the lubricating oil 132, color change of the desiccant 130 associated with degradation of the lubricating oil 132 can be prevented.

### EFFECTS OF EMBODIMENT 2

The gas drying system 100 has a cyclone-type oil removing device 140. This can remove the lubricating oil 132, which is a cause of color change, as much as possible. And distinguishability of color change of the desiccant 130 is improved.

***Description of Test Results***

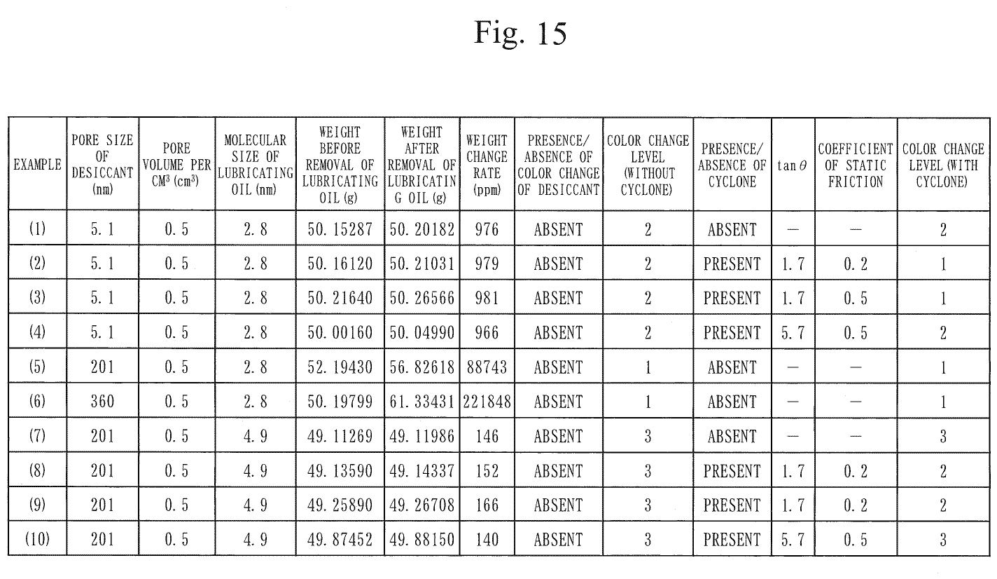

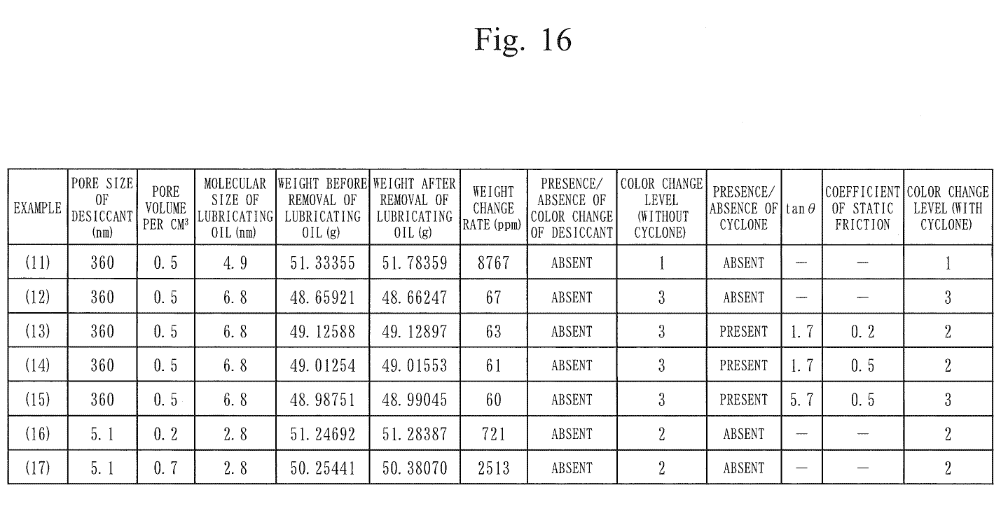

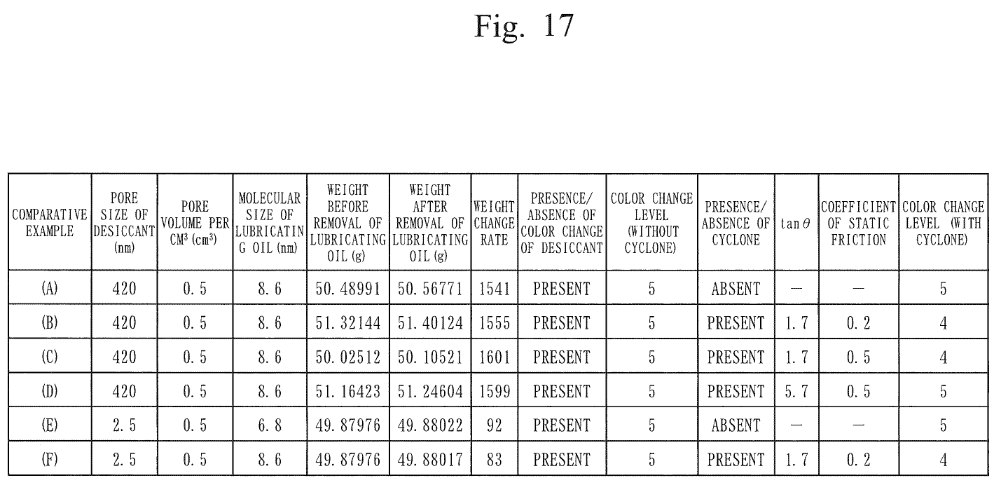

FIGS. 15, 16, and 17 show the results of tests on the color change level of desiccants. FIGS. 15 and 16 show test results in examples of an embodiment and FIG. 17 shows test results in comparative examples for the embodiment.

The range of the pore size of the desiccant is from 5.1 nanometers to 420 nanometers inclusive.

The range of the molecular size of the lubricating oil is from 2.8 nanometers to 8.6 nanometers inclusive.

The color change level of the desiccant is indicated in five levels. A smaller number indicates less color change. Color change levels of 3 or less are practical levels.

Whether lubricating oil will penetrate inside of desiccant by capillarity or it will stay on the surface of the desiccant can be examined in the following manner based on change in the weight of the desiccant before and after its use.

First, a certain amount of desiccant is prepared. Specifically, it is desirable that about 50 g of desiccant is prepared. In this example, activated alumina was used as the desiccant and cobalt chloride was used as the drying indicating agent.

Next, the desiccant is sufficiently dried to remove moisture from the desiccant. For example, the desiccant is dried at 100 degrees for two hours.

Next, the weight of the desiccant is measured and recorded. The weight at this point is referred to as weight A. The weight A is the weight of the desiccant.

Next, the desiccant is used in hydrogen gas that contains lubricating oil.

Next, the desiccant is washed with solution containing surfactant.

Next, the desiccant is sufficiently dried to remove moisture from the desiccant. For example, the desiccant is dried at 100 degrees for two hours.

Then, the weight of the desiccant is measured and recorded. The weight at this point is referred to as weight B. The weight B is the sum of the weight of the desiccant and the weight of the lubricating oil.

If no capillarity occurred and the lubricating oil stays on the surface of the desiccant, the lubricating oil is removed by washing. Due to the influence of lubricating oil that has not completely been removed, the weight B will be a value somewhat higher than the weight A. In this case, a rate of change in the weight is less than 10 ppm.

By contrast, when capillarity occurred, lubricating oil is contained inside the desiccant and hence the lubricating oil cannot be removed by washing. Thus, the weight B will be a value greater than the weight A. In this case, the rate of change in the weight is equal to or higher than 10 ppm.

When the pore volume of the desiccant is small, the volume to draw in lubricating oil is small. On the other hand, if the pore volume of the desiccant is too large, an insufficient strength of the desiccant will occur. Thus, the pore volume per cubic centimeter is preferably from 0.2 cubic centimeters to 0.7 cubic centimeters inclusive.

FIGS. 15 and 16 show the test results for Examples (1 to 17). The range of the pore size of the desiccant is from 5.1 nanometers to 360 nanometers inclusive. The color change levels were 3 or lower. That is, Examples (1 to 17) satisfied the practical levels.

FIG. 17 shows the test results for comparative examples (A to D). The pore size of the desiccant is 420 nanometers, exceeding 360 nanometers. The color change levels were 4 or 5. That is, the comparative examples (A to D) did not satisfy the practical levels.

In Examples (1 to 17), the pore size of the desiccant is larger than the molecular size of the lubricating oil. As a result of measurement in the foregoing manner, the rate of change in the weight of the desiccant was 10 ppm or higher. That is, it was found that the lubricating oil had penetrated inside of the pores of the desiccant by capillarity.

FIG. 17 shows the test results for comparative examples (E, F). In the comparative examples (E, F), the pore size of the desiccant is smaller than the molecular size of the lubricating oil. The color change levels were 4 or 5. That is, the comparative examples (E, F) did not satisfy the practical levels.

As a result of measurement in the foregoing manner, the rate of change in the weight of the desiccant was less than 10 ppm. That is, it was found that the lubricating oil had not penetrated inside of the pores of the desiccant by capillarity.

The Examples (1, 16, 17) have different pore volumes per cubic centimeter within the range of from 0.2 cubic centimeters to 0.7 cubic centimeters inclusive. However, no difference in change level was observed.

For the drying indicating agent, a variety of materials such as cobalt chloride, tetraphenylporphyrin chloride and iron alum were used. However, since the weight proportion of the drying indicating agent in the desiccant was very low, similar results were observed with any of the materials.

As to the inner surface of the container, experiments were conducted with varying combinations of the inclination angle (tanθ) and the coefficient of static friction. The coefficient of static friction varies depending on a coating agent applied to the inner surface of the container. The range of tanθ is from 0.6 to 5.7 inclusive. The range of the coefficient of static friction is from 0.2 to 0.5 inclusive.

Examples (1, 5, 6, 7, 11, 12, 16, 17) and comparative examples (A, E) do not include oil removing devices. In this case, no change was observed in color change level.

Examples (2, 3, 8, 9, 13, 14) include oil removing devices. The oil removing devices includes the container 141 that satisfies the expression (3) above. In this case, further reduction in the color change level was observed.

In comparative examples (B, C, D, F), the pore size of the desiccant is outside the range of from 5.1 nanometers to 360 nanometers inclusive. In this case, it was found that it was impossible to bring the color change level of the desiccant to the practical levels even by introduction of the oil removing device.

***Supplementary Note on Embodiments***

The gas drying system 100 may also be a system for drying hydrogen gas in a device other than the rotating electric machine 101.

The gas drying system 100 may also be a system for drying gas other than hydrogen gas.

The oil that mixes with hydrogen gas may be oil other than oil used as the lubricating oil 132.

The embodiments are illustrative of preferred embodiments and are not intended to limit the technical scope of the present disclosure. The embodiments may be partially practiced or may be practiced in combination with other embodiments.

### REFERENCE SIGNS LIST

100: gas drying system; 101: rotating electric machine; 102: pipe valve; 103: pipe valve; 110: gas drier; 111: inflow pipe; 112: outflow pipe; 113: piping switch; 114: return pipe; 115: drain pipe; 120: drying tower; 120A: drying tower; 120B: drying tower; 120C: drying tower; 121: storage box; 121A: storage box; 121B: storage box; 122: inspection hole; 122B: inspection hole; 123: lid; 124: heater; 124B: heater; 125A: punching metal; 130: desiccant; 130B: desiccant; 131: drying indicating agent; 132: lubricating oil; 139: desiccant; 140: oil removing device; 141: container; 142: valve

1. A gas drying system comprising:
an inflow pipe in which gas that contains moisture and is mixed with oil flows;
a drying tower which is packed with desiccant and which dries gas entering from the inflow pipe with the desiccant; and
an outflow pipe in which gas after being dried in the drying tower flows, wherein
the desiccant has a plurality of pores into which the oil penetrates, the plurality of pores having a pore size greater than or equal to a size of molecules of the oil.

2. The gas drying system according to claim 1, wherein
the desiccant is compounded with a drying indicating agent that changes in color in response to moisture, and
the pore size of the desiccant is equal to or smaller than wavelengths of visible light.

3. The gas drying system according to claim 1, wherein
for the pore size of the desiccant, a maximum value of pore sizes in a pore distribution of the desiccant is from 5.1 nanometers to 360 nanometers inclusive.

4. The gas drying system according to claim 1, wherein
a pore volume of the desiccant per cubic centimeter when packed is from 0.2 cubic centimeters to 0.7 cubic centimeters inclusive.

5. The gas drying system according to claim 1, wherein
the desiccant is any one of silica gel, activated alumina, zeolite, and micro-porous silica.

6. The gas drying system according to claim 1, wherein
the gas is hydrogen gas that is used as a cooling medium in a rotating electric machine in which lubricating oil as the oil is used and that flows out of the rotating electric machine.

7. The gas drying system according to claim 1, wherein
the drying tower includes a storage box that is packed with the desiccant, and
the storage box is shaped such that a portion into which the gas flows from the inflow pipe is narrow.

8. The gas drying system according to claim 1, wherein
the drying tower includes a storage box that is packed with the desiccant, and
the storage box includes punching metal in a portion into which the gas flows from the inflow pipe.

9. The gas drying system according to claim 1, wherein
the desiccant is one of a plurality of kinds of desiccants that are different in at least either of pore size and material, and
the plurality of kinds of desiccants are packed in the drying tower in separate layers for the respective kinds.

10. The gas drying system according to claim 1, comprising:
a gas drier including the inflow pipe, a first drying tower as the drying tower, and the outflow pipe; and
a second drying tower that is connected to an outlet side of the outflow pipe, is packed with a desiccant which is different from the desiccant of the first drying tower in at least either of pore size and material, and dries gas that enters from the outflow pipe.

11. The gas drying system according to claim 1, comprising:
a gas drier including the inflow pipe, the drying tower, and the outflow pipe; and
an oil removing device which is connected in a middle of the inflow pipe and removes the oil from gas flowing in the inflow pipe in a cyclone manner.

12. The gas drying system according to claim 11, wherein
the oil removing device includes a container which has a conical inner surface and in which the gas flows spirally along the inner surface, and
an inclination angle θ of the inner surface and a coefficient of static friction μ of the inner surface satisfy tanθ<1/μ.

13. The gas drying system according to claim 12, wherein
the inner surface has a coating applied thereon.

14. The gas drying system according to claim 13, wherein
the coating is any one of fluorocarbon polymer coating, ceramic coating, and glass coating.

15. A gas drier comprising:
an inflow pipe in which gas that contains moisture and is mixed with oil flows;
a drying tower which is packed with desiccant and which dries gas entering from the inflow pipe with the desiccant; and
an outflow pipe in which gas after being dried in the drying tower flows, wherein
the desiccant has a plurality of pores into which the oil penetrates, the plurality of pores having a pore size greater than or equal to a size of molecules of the oil.
